(19) United States
(12) Patent Application Publication
(10) Pub. No.: US 2009/0279976 A1
(43) Pub. Date: Nov. 12, 2009

(54) Versatile Shipping Platform

(76) Inventors: Bernard Saul Sain, Jacksonville, FL (US); Kinda Amirdash, Jacksonville, FL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/419,725

(22) Filed: Apr. 7, 2009

Related U.S. Application Data
(60) Provisional application No. 61/071,654, filed on May 9, 2008.

(51) Int. Cl. B60P 7/06; B60P 3/07; B60P 1/64; B65D 88/12

(52) U.S. Cl. 410/46

(57) ABSTRACT

A shipping platform for transporting over-dimensional items, adapted for stacking above or below the decks of container ships on top of standard sized ISO cargo containers. The shipping platform has a base and foldable end frames. The shipping platform is wider than a standard ISO shipping container. The base has transverse end beams that are sufficiently rigid to allow the shipping platform to be mounted atop the corner posts of the standard ISO shipping container and support that portion of the shipping platform that extends beyond the width of the ISO shipping container.

### CLAIM OF PRIORITY

This application claims priority from U.S. Provisional Patent Application Ser. No. 61/071,654, filed on May 9, 2008, which is incorporated herein in their entirety.

### FIELD OF THE INVENTION

This application relates to shipping platforms for transporting cargo on container ships, and more specifically to an oversized shipping platform for transporting large vehicles and other over-dimensional items, adapted for stacking above or below the decks of container ships. Examples of shipping platforms are disclosed in U.S. Pat. Nos. 6,533,510; 7,011,479; 7,040,848; and 7,140,821, all of which are incorporated herein by reference.

### BACKGROUND OF THE INVENTION

The holds of modern container ships are usually constructed to receive ISO (International Standards Organization) containers that measure 40 feet in length, by 8 feet in width, by 8 feet 6 inches in height. The holds have bulkheads, spaced about 40 feet apart, that extend laterally from port to starboard. These bulkheads are provided with vertically extending cells that are sized to permit the 40 feet by 8 feet ISO containers to be slid down between protruding, vertically extending T-shaped cell guide members, which define the width of the cells. The number and depth of the cells, as well as the thickness of the T-shaped cell guide members, depend on the vessel class and age. With this construction, the containers can be secured against both rolling and pitching of the container ship. After a hold is filled with the ISO containers, a cover may be placed over the hatch to close the hold. Containers then can be stacked above deck, over the hatches.

Stacked ISO containers typically are joined together by twist-lock devices that engage the apertures of twist-lock corner castings of adjacent containers. The containers bear the considerable weight of superposed containers by virtue of the columnar strength of their robust corner posts, which are vertically aligned with others in the stack of standard ISO containers.

Containers wider than 8 feet also are used on container ships. These containers, too, have robust corner posts. Shipping platforms of the type disclosed in the aforementioned patents also may be wider than ISO containers, e.g., 12 feet wide, and also have robust vertical load-bearing frames, which may be adjustable in height depending on load height, and foldable for compactness when no load is carried. If a wider container or a wider shipping platform were to be placed on a stack of 8 feet wide ISO containers, not all of the corner posts or load-bearing frames would be aligned. In order to avoid improper load distribution, one must resort to interposing separate stacking devices between the diverse cargo layers, such as the stacking devices disclosed in U.S. Pat. Nos. 6,027,291 and 6,793,448, both of which are incorporated herein by reference. Such stacking devices properly transfer the load of the wider containers or shipping platforms to the corner posts of the 8 feet wide ISO containers.

### SUMMARY OF THE INVENTION

The shipping platform of this invention, which is wider than 8 feet, obviates the need for stacking devices when platforms of this type are to be stacked on 8 feet wide ISO containers, either above deck or below in cargo holds (although such stacking devices may still be used, if desired). When used below deck, the shipping platform of the present invention spans more than one cell in the hold, and its robust construction enables it partially to overhang an adjacent and underlying ISO container without sagging and without loading the adjacent and underlying ISO container improperly. The shipping platform has a base with a cargo floor that preferably is sloped at both ends to facilitate the loading and unloading of wheeled cargo. The shipping platform of the present invention also has a robust, upright load-bearing frame at each end (“end frame”), which may be foldable parallel to the cargo floor for compactness when the shipping platform is empty and is to be moved about or stowed in that folded condition. The end frames optionally can be adjustable in height. Strategically placed twist-lock apertures enable connection of the shipping platform to adjacent shipping platforms or to ISO containers in the same or in an adjacent stack; and they serve as lift points for a gantry crane or other conventional types of lift equipment for handling the shipping platform when the end frames are upright or folded. Optional fork lift pockets in the base also facilitate handling of the shipping platform.

Preferably the shipping platform is about 12 feet wide so that it can span one-and-one-half 8 feet wide ISO containers. Consequently, when two such 12 feet wide shipping platforms are placed side by side (totaling 24 feet in width), the 12 feet wide shipping platforms can exactly span three side-by-side 8 feet wide ISO containers. The preferred height of the shipping platform is about 12 feet, 9 inches (with end frames upright), making the shipping platform one-and-one-half times the height of a low-cube ISO container, which is 8 feet, 6 inches high. As a result, the combined height of two stacked shipping platforms (25 feet, 6 inches) equals the combined height of three stacked low-cube ISO containers. Further, the preferred height of a folded shipping platform is about 4 feet, 3 inches at the corners, which is half the height of an ISO container, so that the combined height of two folded and stacked shipping platforms equals the height of one low-cube ISO container. These width and height dimensions for the shipping platform thus facilitate close-packed configurations of shipping platforms and ISO containers, maximizing space utilization. The length of the shipping platform preferably is about 40 feet so that it can fit in the holds of modern container ships and engage the T-shaped cell guide members on the bulkheads of the hold. Cell guide slots at appropriate locations on each end of the shipping platform are provided for this purpose. The shipping platform may be longer than 40 feet if used only above deck. Built-in lashing points around the perimeter of the shipping platform facilitate securing the cargo to the shipping platform.

Further objects, features and advantages will become apparent upon consideration of the following detailed description of the invention when taken in conjunction with the drawings and the appended claims.

### BRIEF DESCRIPTION OF THE DRAWINGS

FIG. 1 is a corner perspective view of a shipping platform according to the invention.

FIG. 2 is an end perspective view of the shipping platform of FIG. 1.

FIG. 3 is a top plan view of the base of the shipping platform of FIG. 1, with a portion of the cargo floor cut away and the end frames removed for clarity.

FIG. 4 is a longitudinal sectional view of the base taken along line 4-4 in FIG. 3.

FIG. 5 is a transverse sectional view of the base taken along line 5-5 in FIG. 3.

FIG. 6 is a detail sectional view of one end beam of the base taken along 6-6 in FIG. 3.

FIG. 7 is a front elevation view of an end frame of the shipping platform of FIG. 1.

FIG. 8 is a side elevation view of the end frame of FIG. 7.

FIG. 9 is a top plan view of the end frame of FIG. 7.

FIG. 10 is an end elevation view of the shipping platform of FIG. 1, showing the end frame in a upright position and two side brace frames swung inwardly and tied together.

FIG. 11 is a composite side elevation view of the shipping platform of FIG. 1, showing an upright end frame on the right side, and showing a folded end frame on the left side with another shipping platform and folded end frame stacked thereon.

FIG. 12 is a perspective view of two 12 feet wide shipping platforms according to the invention (with end frames folded) stacked atop two adjacent and underlying 8 feet wide ISO containers, with the upper shipping platform engaged by a gantry crane.

FIG. 13 is an end perspective view of several stacks of 8 feet wide ISO containers and 12 feet wide shipping platforms according to the invention in the hold of a ship.

FIG. 14 is an end perspective view, similar to FIG. 13, showing a different arrangement of ISO containers and shipping platforms.

FIG. 15 is a close-up of a portion of FIG. 13, showing the shipping platform's cell guide openings in alignment with those of the containers.

FIG. 16 is a corner perspective view showing the manner in which 8 feet wide ISO containers and 12 feet wide shipping platforms according to the invention can be securely disposed in the hold of a container ship.

### DETAILED DESCRIPTION OF THE PREFERRED EMBODIMENT

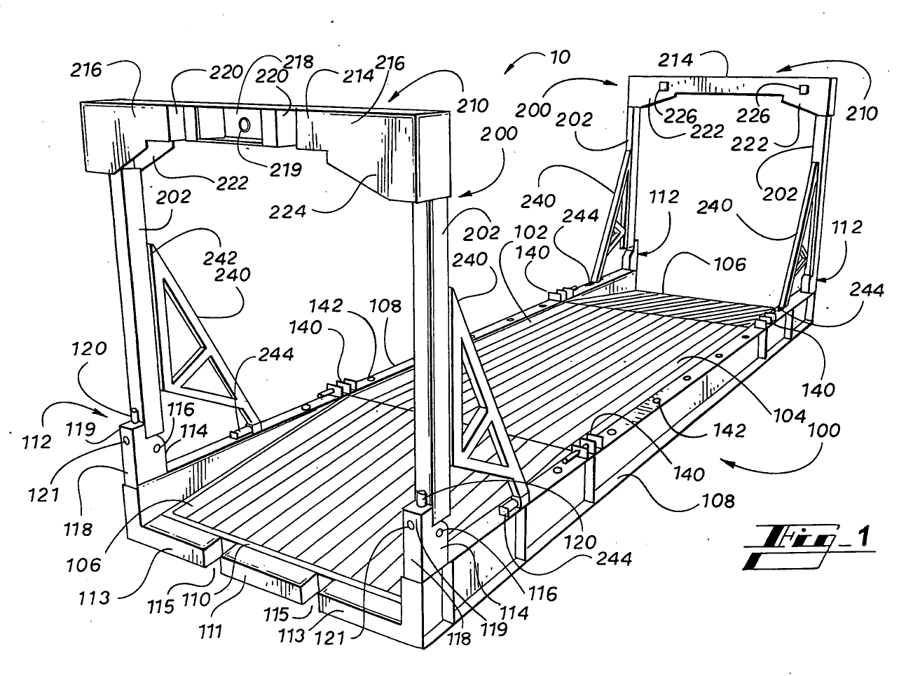

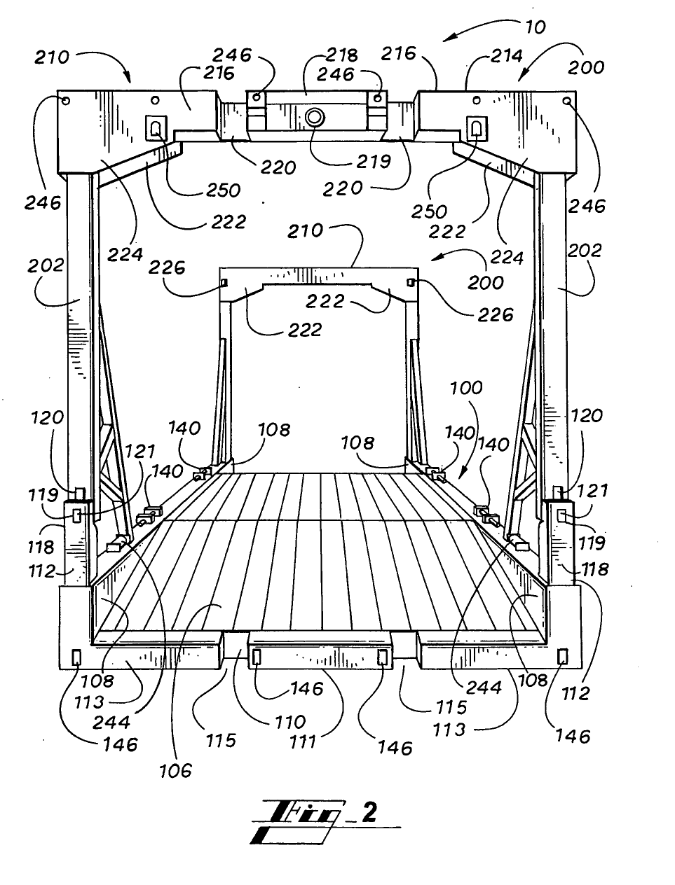

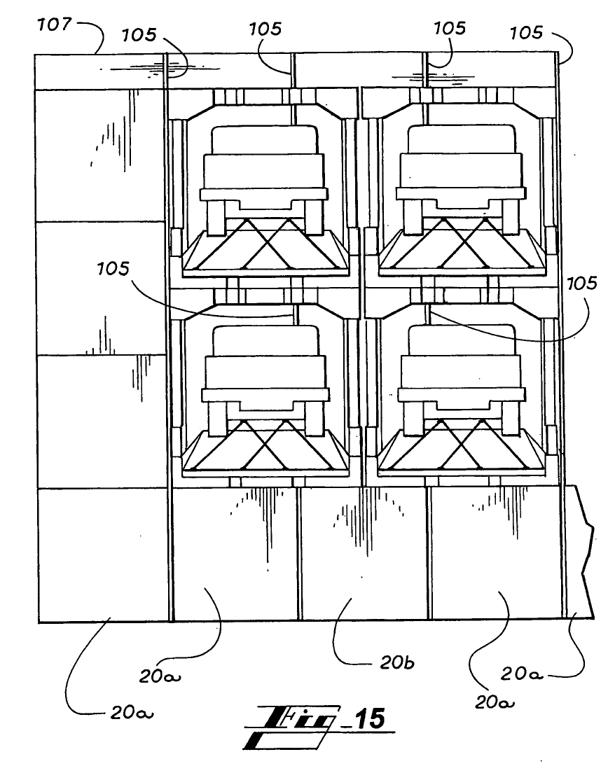

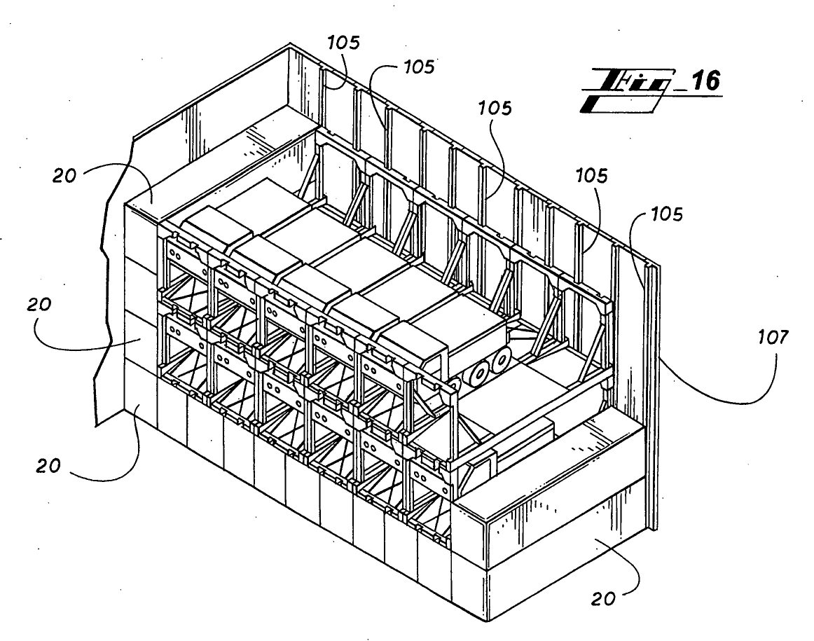

Referring to FIGS. 1 and 2, a 12 feet wide by 40 feet long shipping platform 10 according to the invention generally comprises a base 100 and two end frames 200 that are hinged to the base. The base 100 comprises a cargo floor 102 having a central flat section 104 and sloping end sections 106 at opposite ends of the central flat section 104. The structural perimeter of the base 100 is comprised of I-beam type, web-reinforced side rails 108, and robust tubular end beams 110 welded to the side rails 108. A center sloped projection 111 and two side sloped projections 113 are welded to the front face of each box tubular end beam 110 and define two cell guide slots 115 that are spaced and sized such that one slot 115 on each end of the shipping platform 10 will always engage a T-shaped cell guide member 105 on a bulkhead 107 in the hold of a cargo ship (FIGS. 13-16). Specifically, for this 12 feet wide shipping platform 10, the cell guide slots 115 are about 12 inches deep, about 12 inches wide, and about 5 feet on center to accommodate variations in the location and thickness of the T-shaped cell guide members 105 on the bulkheads 107. The sloped top surfaces of side sloped projections 113 are rough to maximize traction as a vehicle is driven up onto the cargo floor 102.

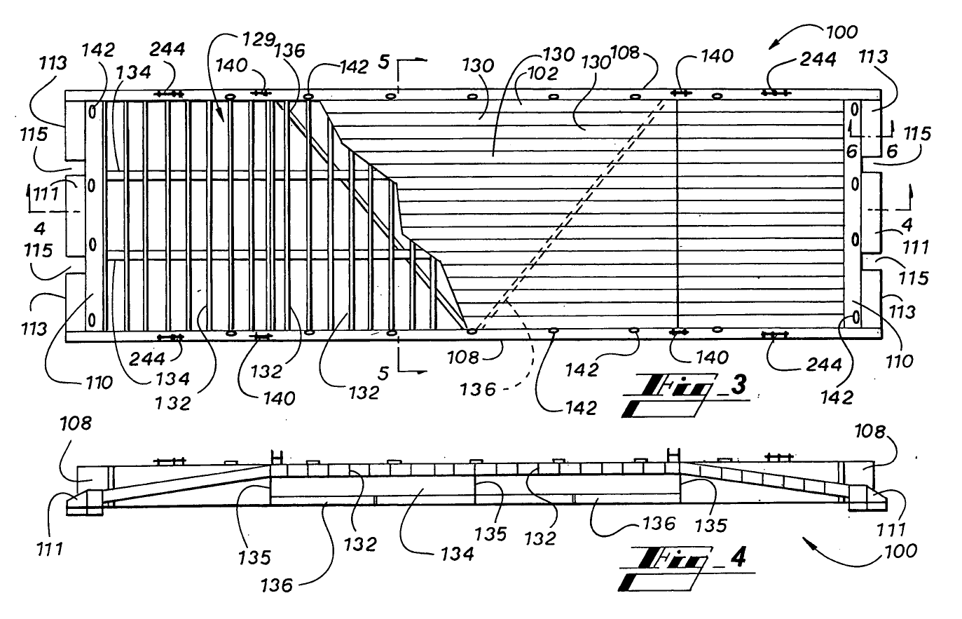

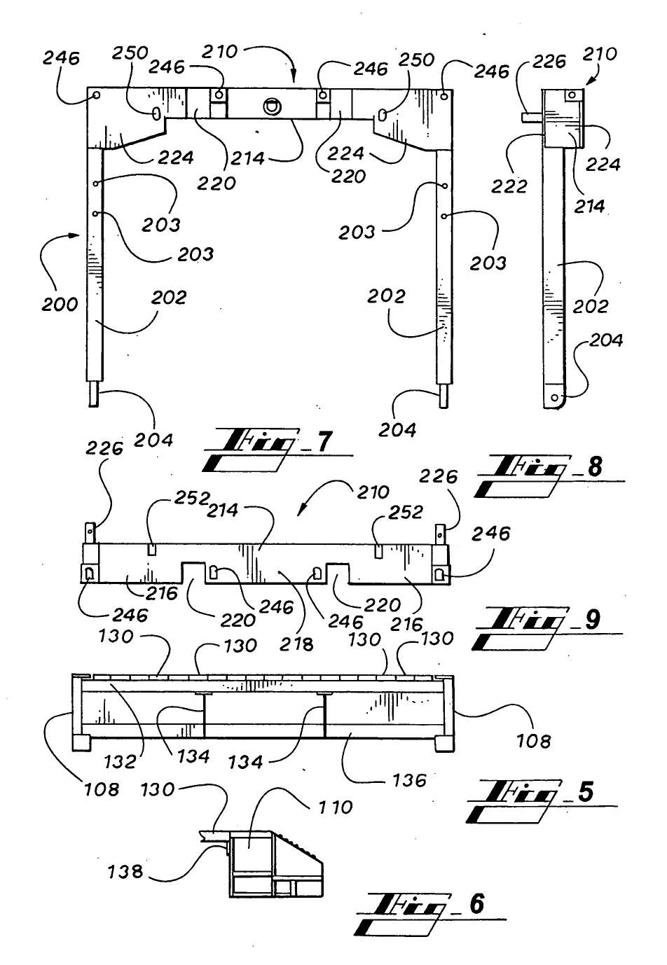

Referring to FIGS. 3-6, the cargo floor 102 preferably comprises longitudinal wooden planks 130 screwed to an underlying base support structure 129. The base support structure 129 comprises laterally extending joists 132 welded at their ends the side rails 108, and supported centrally by a longitudinal I-beams-type center rails 134. In addition, three laterally extending C-section members 135 connect the center rails 134 to each other and to the side rails 108, near the bottom. Diagonal braces 136 stiffen the entire support structure. The ends of the planks 130 adjacent each tubular end beam 110 rest on a flange 138 welded to the tubular end beam 110 (FIG. 6). Cargo tie-down rings 142 are provided around the perimeter of the base 100 and are hinged to the side rails 108 and to the tubular end beams 110.

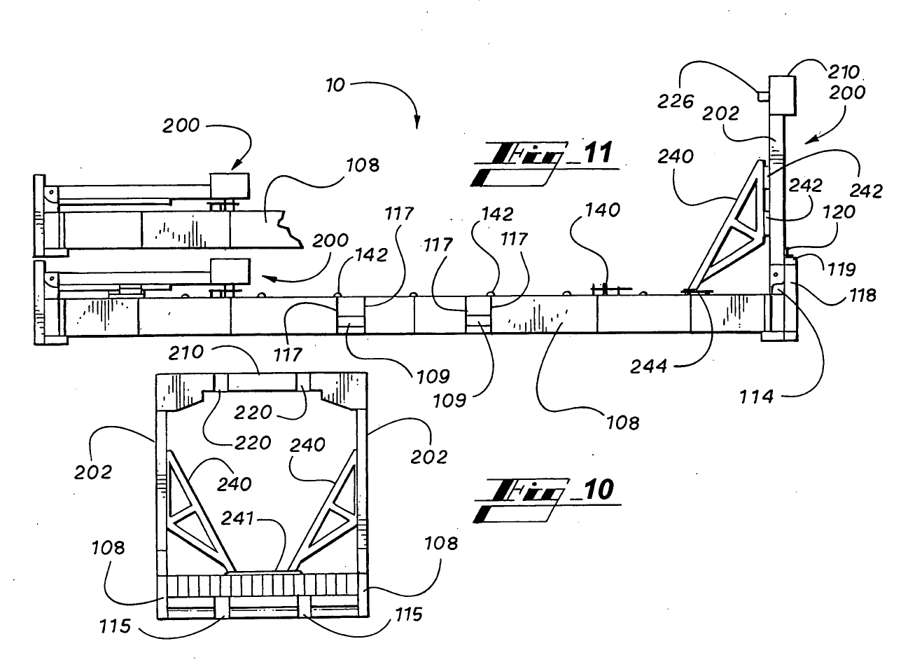

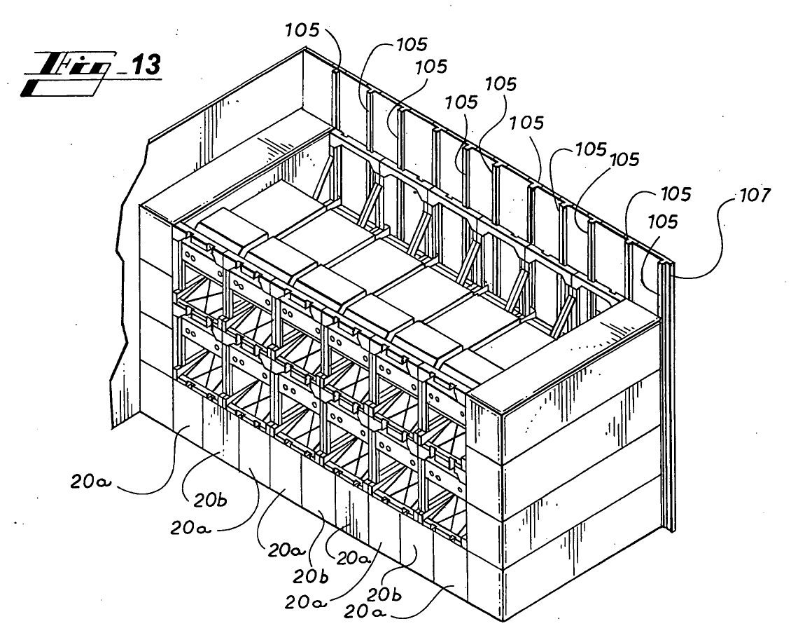

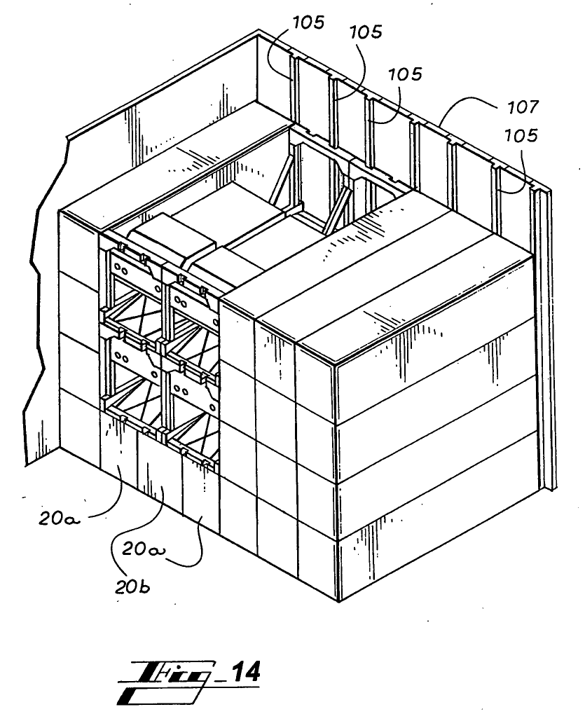

Referring again to FIGS. 1 and 2, upstanding hinge assemblies 112 at the ends of side rails 108 provide pivotal mounting points for corner posts 202 of end frames 200. Each hinge assembly 112 has a pair of spaced aperture plates 114 between which the lower end 204 of one of the corner post 202 is hinged by means of a hinge pin 116 (FIGS. 7 and 8). Hinge assembly 112 also has a post-like member 118 with an ISO corner casting 119 welded on top. The post-like member 118 provides an upright shoulder that serves as a rotational stop for the corner post 202 in its upright position. Each corner post 202 also carries a safety lock assembly 120, which connects to the corner casting 119 when the end frame 200 is upright. The safety lock assembly 120 ensures that the end frame 200 will not drop unintentionally from an upright position when its side brace frames 240 are not secure, such as during end frame erecting or folding procedures. The post-like members 118 also facilitate alignment during stacking of folded shipping platforms by providing corner casting apertures 121 for engaging semi-automatic twist-locks for stacking and shipping (FIGS. 10 and 12). The height of post-like members 118 is about 4 feet, 3 inches, which is half the height of the low-cube ISO container 20. Consequently, when two folded shipping platforms 10 are stacked on each other, the combined height of the two stacked shipping platforms 10 equals the height of one low-cube ISO container 20.

Side brace frames 240, each of which is pivotally connected to a respective corner post 202 by a pair of hinges 242 (FIG. 10), stably support the end frames in an upright position when the lower ends of the side brace frames 240 are secured to the tops of the side rails 108. Securement of the end frames is provided by four brace frame lock shaft assemblies 244 carried by the side rails 108. Each lock shaft assembly 244 includes a slidable lock shaft releasably engageable with an aperture in the lower end of an adjacent side brace frame 240.

Referring to FIGS. 1, 2, and 7-11, a header assembly 210 interconnects the tops of the corner posts 202 of each end frame 200. Header assembly 210 comprises a number of members welded together to form a top beam 214 having two side projecting portions 216 and one central projecting portion 218. A D-ring 219 is attached to the central projecting portion 218. The D-ring 219 is used to raise from and lower the end frame 200 its folded position (FIGS. 11 and 12) and its upright position (FIGS. 1 and 2). Projecting portions 216 and 218 together define two upper cell guide slots 220 that are as wide as the lower cell guide slots 115 and are vertically aligned with the lower cell guide slots 115 so that one of the upper guide slots 220 also will always engage a T-shaped cell guide member 105 on a bulkhead 107 in the hold of a cargo ship. Inner and outer gusset plates 222 and 224 are welded to top beam 214 and to corner posts 202. A pair of aperture lock bars 226 project inwardly near the upper end of each end frame 200, and are adapted to be pinned to aperture side rail lock plates 140 on side rails 108 when the end frames 200 are released from brace lock shaft assemblies 224 and folded. When the end frames 200 are folded, the lower ends of each pair of side brace frames 240 preferably are stabilized by means of a stabilizing rod 241 (FIGS. 11 and 12) that couples the ends together.

In a standard configuration, the preferred height of the end frames 200 of the shipping platform 10 is about 12 feet, 9 inches (with end frames upright), making the shipping platform 10 one-and-one-half times the height of the low-cube ISO container 20, which is 8 feet, 6 inches high. Consequently, the combined height of two stacked shipping platforms 10 (25 feet, 6 inches) equals the combined height of three stacked ISO containers 20. In an alternative embodiment, the height of the end frames 200 can be adjusted to take into account cargo size and/or headroom factors. This can be accomplished by adjustably connecting the header assembly 210 to the corner posts 202 by means of, for example, inner posts (not shown) integral with the header assembly 210 that telescope into the upper ends of the hollow corner posts 202, each inner post secured by a pin that extends through aligned holes 203 in the telescoping members (FIG. 7).

Twist-lock apertures 146, 246, 250, and 252 are provided at strategic locations on the shipping platform 10 to permit the shipping platform 10 to mate with conventional ISO containers 20 and other shipping platforms 10 and to permit loading and unloading by commonly used cranes and other loading devices. Referring to FIGS. 1, 2, and 11, each end of the base 100 has two outboard twist-lock apertures 146 formed near the corners of the base, and two inboard twist-lock apertures 146 formed near the corners of projection 111 (FIG. 2). Referring additionally to FIGS. 2 and 7, each header assembly 210 similarly has two outboard twist-lock apertures 246 formed near the corners of the header, and two inboard twist-lock apertures 246 formed near the corners of projection 218. The horizontal spacing of these lower twist-lock apertures 146 and upper twist-lock apertures 246 is the same, viz., the horizontal spacing between the corner twist-lock apertures of 8 feet wide ISO containers 20. Thus, as seen in FIGS. 12-16, when shipping platforms 10 according to the invention are stacked above (or below) 8 feet wide ISO containers 20, two twist-lock apertures of each shipping platform 10 are vertically aligned with the corner twist-lock apertures of ISO containers 20 below. Consequently, all of the shipping platforms 10 and the ISO containers 20 can be secured together, and the cell guide slots 115 and 220 of the shipping platform 10 can accommodate the T-shaped cell guide members 105 of any thickness.

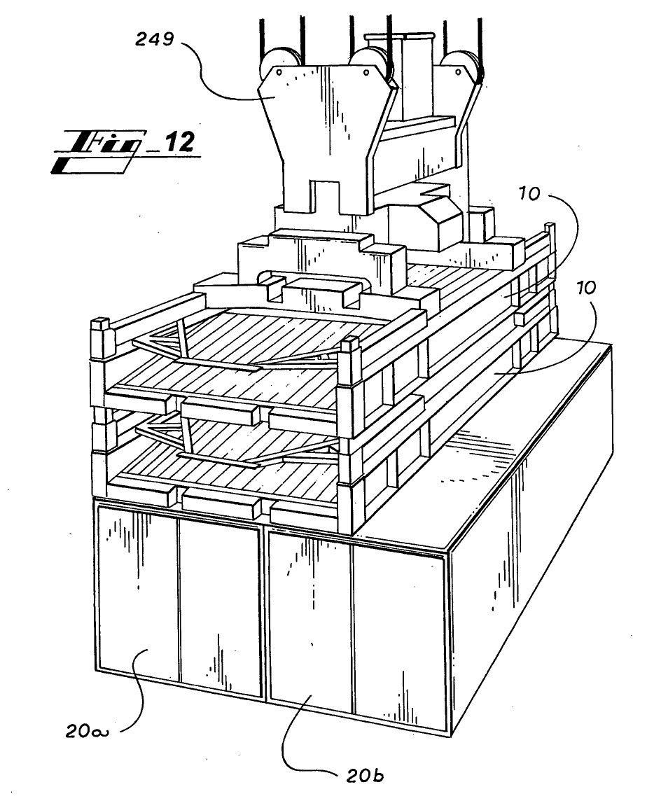

Two additional inboard twist-lock apertures 250 (FIG. 2) are provided below the top of each header assembly 210. These twist-lock apertures 250 face upwardly when the end frames 200 are folded and serve as lift points for a gantry crane 249 or other type of lift equipment (FIG. 12). Another pair of twist-lock apertures 252 are provided along the top of header assembly 210 for picking up the erected units (FIG. 9). Twist-lock apertures 252 are located in such a way as to allow the gantry crane's spreader to clear the upper cell guide slots 220 in the header assembly 210.

In order to facilitate handling of the shipping platform 10 by a forklift, optional forklift pockets 109 (FIG. 10) are formed by two open transverse tubes that extend into the width of the shipping platform 10 and are welded to the side rails 108 and to the center rails 134. The forklift pockets 109 preferably are symmetrically arranged lengthwise of the shipping platform 10, and are about 6 inches high, about 16 inches wide, and about 6 feet, 8¾ inches on center. Vertical stiffening ribs 117 are welded to the side rails 108 adjacent the forklift pockets 109 for added reinforcement.

Steel is the preferred material for most components of the shipping platform 10 according to the invention, and welding is the preferred method of making virtually all of the permanent connections. One major exception is the cargo floor 102, which, as noted, preferably is made of pressure-treated wood planks 130 that are screwed to the underlying latterly extending joists 132. Screw fasteners facilitate replacement of broken and worn planks as needed. Other suitable materials and fastening methods may be used, as will be appreciated by those skilled in the art.

FIGS. 12-16 illustrate the stacking of the 12 feet wide shipping platform 10 according to the invention atop 8 feet wide ISO containers 20. Particularly, with one longitudinal edge of the shipping platform 10 aligned with one longitudinal edge of the first underlying ISO container 20a (FIG. 12), about one-third of the width of the shipping platform 10 extends over one-half the width of the second adjacent and underlying ISO container 20b. While the central portion of the second adjacent and underlying ISO container 20b is not as strong vertically as its corner posts, the second adjacent and underlying ISO container 20b is not subject to damage by the overhanging portion of the shipping platform 10 because of the high lateral bending stiffness of the base 100 of the shipping platform 10. The bending stiffness of the base 100 results from its robust tubular end beams 110 (FIGS. 3 and 6), which are welded to side rails 108 and whose projections 111 and 113 directly overlie the corner posts of the first underlying ISO container 20a. Additional lateral bending stiffness of the entire shipping platform 10 is afforded by the robust, gusseted upright end frames 200, which are solidly secured to the base 100. Thus, the shipping platform 10 remains stable and well-supported at points spaced 8 feet apart primarily by the first underlying ISO container 20a, even though about one-third of the shipping platform's 10 width overhangs the second adjacent and underlying ISO container 20b.

FIGS. 13 and 14 illustrate that two side-by-side shipping platforms 10 according to the invention span the width of three 8 feet wide ISO containers 20, and are well supported by the corner posts of the two outer ISO containers 20a while overhanging the middle ISO container 20b. These figures also illustrate that two stacked shipping platforms 10 according to the invention span the height of three stacked low-cube ISO containers 20. FIG. 16 shows a perspective view of the stack shown in FIG. 14 with the upper cell guide slots 220 engaging the T-shaped cell guide members 105 attached to the bulkhead 107.

While this invention has been described with reference to preferred embodiments thereof, it is to be understood that variations and modifications can be affected within the spirit and scope of the invention as described herein and as described in the appended claims.

I claim:

1. A shipping platform adapted for stacking with cargo containers, wherein the cargo containers have a container width, a container length, and a container height, and wherein the cargo containers have structural corner posts, the shipping platform comprising:
a. a base having a base length and a base width, and wherein the base has rails extending along the base length and end beams, connected to the rails, and extending laterally along the base width at each end of the base; and
b. end frames secured at each end of the base and each end frame having an end frame height and an end frame width, wherein each end frame has end frame corner posts and an end frame header mounted between the corner posts and extending laterally along the frame width,
wherein the base width is longer than the cargo container width so that when the shipping platform is positioned atop a cargo container, the container corner posts support the end beams of the shipping platform with a portion of the base extending beyond the container width and wherein the end beams have sufficient strength to support the portion of the base extending beyond the container width.

2. The shipping platform of claim 1, wherein the end beam has a first end and a second end and wherein the first end is in alignment with the cargo container corner posts and the second end is transversely offset from the cargo container corner posts when the shipping platform is stacked atop a cargo container.

3. The shipping platform of claim 2, wherein the base width is 1.5 times the cargo container width.

4. The shipping platform of claim 1, wherein the end frame height is variable.

5. The shipping platform of claim 4, wherein the end frame height is 1.5 times the container height.

6. The shipping platform of claim 1, wherein the corner posts of the end frames are pivotally mounted to the base by means of a hinge assembly to allow the end frames to be folded onto the base and wherein the hinge assembly includes post-like members, which when the end frames are folded, define a folded height for the shipping platform.

7. The shipping platform of claim 6, wherein the end frames are secured in an upright position by means of side braced frames releasably connecting the corner posts of the end frames to the side rails of the base and wherein the side braced frames are restrained by a stabilizing rod when the side braced frames are disconnected from either the corner posts or the side rails.

8. The shipping platform of claim 6, wherein the folded height is 0.5 times the container height.

9. The shipping platform of claim 6, wherein the hinge assembly includes a safety lock to maintain the end frames in an upright position.

10. The shipping platform of claim 6, wherein the post-like members engage the corner posts of the end frames when the end frames are in an upright position to stop rotation of the corner posts in the hinge assembly.

11. The shipping platform of claim 6, wherein the post-like members have apertures for engaging semi-automatic twist-locks for stacking and shipping folded shipping platforms.

12. The shipping platform of claim 1, wherein the cargo containers and the shipping platform are adapted for stacking in a hold of a ship having bulkheads with spaced cell guide members attached to and extending vertically along the bulkheads and wherein the end beams and the end frame headers of the shipping platform have vertically aligned slots spaced to match spacing between the cell guide members.

13. The shipping platform of claim 1, wherein the base has transversely extending forklift pockets.
